(19) United States
(12) Patent Application Publication
(10) Pub. No.: US 2016/0201166 A1
(43) Pub. Date: Jul. 14, 2016

(54) HEAT-RESISTANT SUPERALLOY

(71) Applicant: NATIONAL INSTITUTE FOR MATERIALS SCIENCE, Ibaraki (JP)

(72) Inventors: Yuefeng GU, Ibaraki (JP); Hiroshi HARADA, Ibaraki (JP); Toshiharu KOBAYASHI, Ibaraki (JP)

(21) Appl. No.: 15/079,601

(22) Filed: Mar. 24, 2016

Related U.S. Application Data
(63) Continuation of application No. 13/510,630, filed on Jul. 12, 2012, now abandoned.

(30) Foreign Application Priority Data
Nov. 19, 2009 (JP) 2009-263703

(51) Int. Cl. C22C 19/05; F01D 5/02; B21K 1/32

(52) U.S. Cl. CPC C22C 19/055; B21K 1/32; F01D 5/02; F05D 2300/1432

(57) ABSTRACT

A heat-resistant superalloy having chromium, aluminum, cobalt, titanium, and ruthenium added thereto as main components, and having a subcomponent(s) optionally added thereto, the remainder, excluding the main components and the subcomponent(s), comprising nickel and an impurity inevitably contained,
wherein the amount of the chromium added is 2 to 25% by mass,
the amount of the aluminum added is 0.2 to 7% by mass,
the amount of the cobalt added is 19.5 to 55% by mass,
the amount of the titanium added is [0.17×(% by mass for cobalt-23)+3] to [0.17×(% by mass for cobalt-20)+7]% by mass (with the proviso that the amount of the titanium added is 5.1% by mass or more), and
the amount of the ruthenium added is 0.1 to 10% by mass.

### TECHNICAL FIELD

The present invention relates to a heat-resistant superalloy used in a heat-resistant member for use in aircraft engine, generator gas turbine, or the like, particularly used in a turbine disk, a turbine blade, or the like.

### BACKGROUND ART

A turbine disk, which is a heat-resistant member for use in aircraft engine, generator gas turbine, or the like, is a part which supports a moving blade and rotates at a high speed. Therefore, the turbine disk requires a material which endures a very large centrifugal stress and which is excellent in fatigue strength, creep strength, and fracture toughness. On the other hand, as the engine and generator are being improved in the fuel consumption rate and performance, there are demands that the engine gas temperature should be improved and that the turbine disk should be reduced in weight, and therefore the material for turbine disk is required to have higher heat resistance and higher strength.

Generally, a Ni-based forging alloy is used in the turbine disk, and, for example, Inconel 718 utilizing a γ″ (gamma double prime) phase as a strengthening phase and Waspaloy having a γ′ (gamma prime) phase, which is more stable than the γ″ phase, deposited in an amount of about 25 vol % and utilizing the γ′ phase as a strengthening phase have been widely used. Further, from the viewpoint of dealing with an increase of the temperature, Udimet 720 developed by Special Metals has been introduced since 1986. Udimet 720 has a γ′ phase deposited in an amount of about 45 vol % and has tungsten added for strengthening the solid solution of γphase, and exhibits excellent heat resistance properties. Udimet 720, meanwhile, has poor structure stability such that a detrimental TCP (topologically close packed) phase is formed in the Udimet 720 being used. Therefore, Udimit 720Li (U720Li/U720L1) has been developed by improving Udimet 720, e.g., reducing the chromium content. In Udimit 720Li, however, a TCP phase is inevitably formed, and the use of Udimit 720Li for a long time or at high temperatures is limited. Further, with respect to Udimit 720 and Udimit 720 Li, a difference between the γ′ solvus temperature and the initial melting temperature is small, and the narrow process window for hot processing, heat treatment, or the like has been pointed out. Thus, Udimit 720 and Udimit 720 Li have a practical problem in that it is difficult to produce a homogeneous turbine disk from them by a casting or forging process.

Powder metallurgy alloys, including AF115, N18, and Rene 88DT as representative examples, are sometimes used in a high-pressure turbine disk required to have a high strength. The powder metallurgy alloys have merit in that a homogeneous disk having almost no segregation despite containing strengthening elements in a large amount can be obtained. On the other hand, the powder metallurgy alloys pose a problem in that, for preventing contaminants from mixing into the alloy, a thorough control of the production process, e.g., vacuum dissolution with high cleanness or optimal selection of the mesh size for powder classification is required, increasing the cost.

By the way, with respect to conventional Ni-based heat-resistant superalloys, a number of improvements of the chemical compositions have been proposed. The heat-resistant superalloys having improved chemical compositions have cobalt, chromium, and molybdenum, or molybdenum, tungsten, aluminum, and titanium added thereto as main components, and representative examples of such superalloys include those having one of or both of niobium and tantalum as essential components. However, these chemical compositions are suitable for powder metallurgy, but make casting or forging of the superalloy difficult. Further, the amount of the cobalt added to the heat-resistant superalloy is relatively large, but, taking into consideration the cost and the like, the amount of the cobalt added was limited to 23% by mass or less, excluding a specific case.

Titanium has a function of strengthening the γ′ phase and is effective in improving the tensile strength or crack propagation resistance, and therefore titanium is added to the heat-resistant superalloy. However, the addition of titanium in an excess amount increases the γ′ solvus temperature, and further forms a detrimental phase, making it difficult to obtain a sound γ′ structure. From the viewpoint of avoiding this, the amount of the titanium added to the heat-resistant superalloy was limited to about 5% by mass.

The present inventors have found that by positively adding cobalt in an amount of up to 55% by mass, the formation of a detrimental TCP phase can be suppressed, and that by increasing both cobalt and titanium in a predetermined proportion, the γ/γ′ two-phase structure can be stabilized, and have proposed a heat-resistant superalloy which can endure for a long time even in a higher temperature region.
Patent document 1: Japanese Patent No. 2666911
Patent document 2: Japanese Patent No. 3145091
Patent document 3: Japanese Patent No. 3233361
Patent document 4: Japanese Patent No. 4026883
Patent document 5: WO2006/059805 pamphlet

### DISCLOSURE OF THE INVENTION

### Problems that the Invention is to Solve

The above-mentioned heat-resistant superalloy already proposed by the present inventors has both cobalt and titanium increased in a predetermined proportion and is a novel alloy having excellent heat resistance. With respect to this heat-resistant superalloy, however, it has additionally been found that when titanium is added in too large an amount, an η phase (Ni₃Ti) is likely to be formed in the heat-resistant superalloy. The η phase is in a plate form and causes the ductility of the heat-resistant superalloy around at room temperature to be poor. Further, the η phase is also in a cell form and causes the notched stress rupture strength of the heat-resistant superalloy to lower. Therefore, the development of a heat-resistant superalloy having a good balance between excellent heat resistance and easy processing properties and having high reliability is strongly desired.

### Means for Solving the Problems

The present inventors have made extensive and intensive studies on technical means for controlling the formation of the above-mentioned η phase. As a result, it has been newly found that the addition of ruthenium to the heat-resistant superalloy proposed by the present inventor exhibits a remarkably effect of suppressing the formation of an η phase in the superalloy, and the present invention has been completed, based on the above novel finding.

For solving the above problems, the heat-resistant superalloy of the invention is a heat-resistant superalloy having chromium, aluminum, cobalt, titanium, and ruthenium added thereto as main components, and having a subcomponent(s) optionally added thereto, the remainder, excluding the main components and the subcomponent(s), comprising nickel and an impurity inevitably contained,
wherein the heat-resistant superalloy is characterized in that:
the amount of the chromium added is 2 to 25% by mass,
the amount of the aluminum added is 0.2 to 7% by mass,
the amount of the cobalt added is 19.5 to 55% by mass,
the amount of the titanium added is [0.17×(% by mass for cobalt-23)+3] to [0.17×(% by mass for cobalt-20)+7]% by mass (with the proviso that the amount of the titanium added is 5.1% by mass or more), and
the amount of the ruthenium added is 0.1 to 10% by mass.

In the heat-resistant superalloy, it is preferred that the amount of the titanium added is [0.17×(% by mass for cobalt-23)+3] to [0.17×(% by mass for cobalt-20)+7]% by mass (with the proviso that the amount of the titanium added is 5.3 to 11% by mass), and at least one of molybdenum and tungsten is added as the subcomponent,
wherein the amount of the molybdenum added is 5% by mass or less, and
the amount of the tungsten added is 5% by mass or less.

Further, in the heat-resistant superalloy, it is preferred that at least one of zirconium, carbon, and boron is added as the subcomponent,
wherein the amount of the zirconium added is 0.01 to 0.2% by mass,
the amount of the carbon added is 0.01 to 0.15% by mass, and
the amount of the boron added is 0.005 to 0.1% by mass.

Further, in the heat-resistant superalloy, it is preferred that at least one of molybdenum and tungsten and at least one of zirconium, carbon, and boron are added as the subcomponents,
wherein the amount of the molybdenum added is 5% by mass or less,
the amount of the tungsten added is 5% by mass or less,
the amount of the zirconium added is 0.01 to 0.2%by mass,
the amount of the carbon added is 0.01 to 0.15% by mass, and
the amount of the boron added is 0.005 to 0.1% by mass.

Further, in the heat-resistant superalloy, it is preferred that at least one of molybdenum and tungsten, at least one of tantalum and niobium, and at least one of zirconium, carbon, and boron are added as the subcomponents,
wherein the amount of the molybdenum added is 5% by mass or less,
the amount of the tungsten added is 5% by mass or less,
the amount of the tantalum added is 2% by mass or less,
the amount of the niobium added is 2% by mass or less,
the amount of the zirconium added is 0.01 to 0.2% by mass,
the amount of the carbon added is 0.01 to 0.15% by mass, and
the amount of the boron added is 0.005 to 0.1% by mass.

Further, in the heat-resistant superalloy, it is preferred that the amount of the cobalt added is 23.1 to 55% by mass.

Further, in the heat-resistant superalloy, it is preferred that the amount of the titanium added is [0.17×(% by mass for cobalt-23)+3] to [0.17×(% by mass for cobalt-20)+7]% by mass (with the proviso that the amount of the titanium added is 5.1 to 11% by mass).

Further, in the heat-resistant superalloy, it is preferred that the amount of the ruthenium added is 0.1 to 7% by mass.

Further, in the heat-resistant superalloy, it is preferred that the amount of the titanium added is [0.17×(% by mass for cobalt-23)+3] to [0.17×(% by mass for cobalt-20)+7]% by mass (with the proviso that the amount of the titanium added is 5.3 to 10% by mass), and the amount of the ruthenium added is 0.1 to 5% by mass.

Further, in the heat-resistant superalloy, it is preferred that the amount of the zirconium added is 0.01 to 0.15% by mass, the amount of the carbon added is 0.01 to 0.1% by mass, and the amount of the boron added is 0.005 to 0.05% by mass.

Further, it is preferred that the heat-resistant superalloy contains no η phase in the alloy phase. The heat-resistant superalloy member of the invention is characterized in that the member is produced from the above heat-resistant superalloy by at least one of casting, forging, and powder metallurgy.

### Advantage of the Invention

In the invention, there is provided a heat-resistant superalloy having a good balance between excellent heat resistance and easy processing properties and having high reliability.

### BRIEF DESCRIPTION OF DRAWINGS

FIG. 1 shows photomicrographs of the microstructures observed with respect to the comparative alloy 2 (A) and the invention alloy 4 (B) obtained by adding ruthenium in an amount of 4% by mass to the comparative alloy 2, which alloys have been subjected to casting.

FIG. 2 shows XRD diffraction patterns measured with respect to the invention alloy 4 and comparative alloy 2, which have been subjected to aging treatment at 1,140° C. for 100 hours.

FIG. 3 shows photomicrographs of the microstructures observed with respect to the invention alloy 4 {(B) and (D)} and the comparative alloy 2 {(A) and (C)}, which have been subjected to heat treatment at 1,220° C. for one hour, and then subjected to aging at 1,140° C. for 32 hours {(A) and (B)} and for 100 hours {(C) and (D)}.

FIG. 4 shows TTT curves (time-temperature-transformation curves) for the formation of an η phase with respect to the following four types of heat-resistant superalloys: (A) comparative alloy 1; (B) invention alloy 3 (comparative alloy 1+2.5% by mass Ru); (C) comparative alloy 2; and (D) invention alloy 4 (comparative alloy 2+4% by mass Ru).

FIG. 5 shows photographs of the appearance of the comparative alloy 2 (A) and invention alloy 4 (B), which have been subjected to high-temperature forging at 1,100° C. and at 0.1 s⁻¹.

### MODE FOR CARRYING OUT THE INVENTION

In the invention, as already proposed, the contents of cobalt and titanium in the heat-resistant superalloy are appropriately controlled to achieve excellent heat resistance, and further ruthenium is added to the heat-resistant superalloy to thoroughly suppress the formation of an η phase which causes a problem in the processability of the superalloy, improving the processability, and thus a heat-resistant superalloy having a good balance between a heat resistance and easy processing properties is provided.

Ruthenium (Ru) is a component capable of suppressing the formation of a TCP phase, and can improve the creep characteristics of the heat-resistant superalloy at high temperatures. This effect is remarkable when the amount of the ruthenium added to the heat-resistant superalloy is in the range of from 0.1 to 10% by mass. Taking into consideration the fact that ruthenium is an expensive metal and the balance between a heat resistance and easy processing properties, the amount of the ruthenium added is preferably in the range of from 0.1 to 7% by mass, more preferably from 0.1 to 5% by mass.

Cobalt (Co) is a component effective in controlling the solvus temperature of the γ′ phase, and when the amount of the cobalt added to the heat-resistant superalloy is increased, the solvus temperature is lowered to widen the process window, so that an effect of improving the superalloy in forging properties can also be obtained. In addition, cobalt suppresses the formation of a TCP phase to improve the high-temperature strength of the heat-resistant superalloy, and therefore cobalt is positively added to the heat-resistant superalloy in an amount of 19.5% by mass or more. By virtue of the addition of cobalt in such an amount, there is achieved a practical heat-resistant superalloy having a good balance between a heat resistance and easy processing properties even in the region of composition in which the amount of the titanium (Ti) added is 5.1% by mass or more.

When cobalt and titanium are added in combination, for example, in the form of a Co—Ti alloy, it is preferred that the amounts of the cobalt and titanium added are determined in accordance with the below-mentioned formula for the range of the amount of the titanium added. When cobalt is added in an amount of 19.5% by mass or more, and even when cobalt is added in an amount of 23.1% by mass or more, or an amount of up to 55% by mass, the above-mentioned heat-resistant superalloy can be similarly obtained. In this connection, it is noted that, according to the results of a high-temperature compression test, an alloy having cobalt added in an amount of more than 55% by mass tends to be reduced in the strength at up to 750° C. Therefore, generally, the amount of the cobalt added to the heat-resistant superalloy is preferably 55% by mass or less, more preferably 22 to 35% by mass, further preferably 23.1 to 35% by mass.

Titanium is added for strengthening the γ′ to improve the strength of the heat-resistant superalloy, and is required to be added in an amount of 5.1% by mass or more. When titanium and cobalt are added in combination, excellent phase stability is realized, thus achieving the heat-resistant superalloy having high strength. Basically, when selecting, for example, a Co+Co₃Ti alloy which is a heat-resistant superalloy having a γ+γ′ two-phase structure, the addition of titanium achieves a heat-resistant superalloy having a stable structure even in a high alloy concentration and having high strength. With respect to the amount of the titanium added to the heat-resistant superalloy, the lower limit is 5.1% by mass, and further the amount of the titanium added is within the range represented by the following formula:

[0.17×(% by mass for cobalt-23)+3] to [0.17×(% by mass for cobalt-20)+7].

On the other hand, when the amount of the titanium added is more than 15% by mass, the formation of an η phase which is a detrimental phase, or the like may be marked, and therefore the amount of the titanium added is preferably 15% by mass or less. It is more preferred that the amount of the titanium added satisfies the above-mentioned formula for the range and further is 5.1 to 15% by mass, advantageously 5.3 to 11% by mass, further advantageously 5.3 to 10% by mass.

Chromium (Cr) is added for improving the environmental resistance or fatigue crack propagation characteristics of the heat-resistant superalloy. The amount of the chromium added to the heat-resistant superalloy is in the range of from 2 to 25% by mass. When the amount of the chromium added is less than 2% by mass, desired properties cannot be obtained. When the amount of the chromium added is more than 25% by mass, a detrimental TCP phase is likely to be formed. The amount of the chromium added is preferably 5 to 20% by mass, more preferably 10 to 18% by mass.

Aluminum (Al) is an element which forms a γ′ phase, and the amount of the aluminum added to the heat-resistant superalloy is in the range of from 0.2 to 7% by mass so that the γ′ phase is formed in an appropriate amount. The ratio of the titanium and aluminum contained in the heat-resistant superalloy affects the formation of an η phase and therefore, for suppressing the formation of a TCP phase which is a detrimental phase, the amount of the aluminum added is preferably as large as possible within the above-mentioned range.

Tungsten (W) is a component effective in dissolving in the γphase and γ′ phase and strengthening the both phases to improve the high-temperature strength of the heat-resistant superalloy. When the amount of the tungsten added to the heat-resistant superalloy is too small, the resultant superalloy is likely to have unsatisfactory creep characteristics. On the other hand, when the amount of the tungsten added is too large, the resultant superalloy has an excessively increased alloy density and is disadvantageous from a practical point of view. The amount of the tungsten added is generally 5% by mass or less.

Molybdenum (Mo) is a component effective in strengthening mainly the γphase to improve the creep characteristics of the heat-resistant superalloy. Molybdenum, meanwhile, is an element having a high density like tungsten, and when the amount of the molybdenum added to the heat-resistant superalloy is too large, the resultant superalloy has an excessively increased alloy density and is disadvantageous from a practical point of view. The amount of the molybdenum added is generally 5% by mass or less, preferably 4% by mass or less.

Carbon (C) is a component effective in improving the ductility and creep characteristics of the heat-resistant superalloy at high temperatures. The amount of the carbon added to the heat-resistant superalloy is generally in the range of from 0.01 to 0.15% by mass, preferably in the range of from 0.01 to 0.1% by mass. Boron (B) is a component effective in improving the creep characteristics at high temperatures, fatigue characteristics, and the like of the heat-resistant superalloy. The amount of the boron added to the heat-resistant superalloy is generally in the range of from 0.005 to 0.1% by mass, preferably in the range of from 0.005 to 0.05% by mass. When the amounts of the carbon and boron added exceed the above-mentioned respective predetermined ranges, it is likely that the creep strength of the heat-resistant superalloy is lowered or the process window narrows. Zirconium (Zr) is a component effective in improving the ductility, fatigue characteristics, and the like of the heat-resistant superalloy. The amount of the zirconium added to the heat-resistant superalloy is generally in the range of from 0.01 to 0.2% by mass, preferably in the range of from 0.01 to 0.15% by mass.

Examples of other components include tantalum (Ta), niobium (Nb), rhenium (Re), vanadium (V), hafnium (Hf), and magnesium (Mg), and these components can be added to the heat-resistant superalloy in such an appropriately controlled amount that the properties of the heat-resistant superalloy are not sacrificed.

Examples are shown below. The following Examples should not be construed as limiting the scope of the present invention.

### EXAMPLES

Four types of invention alloys and two types of comparative alloys were prepared by melting in a vacuum induction heating method. The chemical compositions of these alloys are shown in Table 1.

TABLE 1

| | Name of alloy | | | | | | | | | | |
|---|---|---|---|---|---|---|---|---|---|---|---|
| | Ni | Co | Cr | Mo | W | Al | Ti | C | B | Zr | Ru |
| Comparative | Bal. | 23.1 | 16.8 | 3.12 | 1.25 | 1.87 | 5.44 | 0.03 | 0.018 | 0.022 | — |
| alloy 1 | | | | | | | | | | | |
| Invention alloy 1 | Bal. | 23.0 | 16.7 | 3.1 | 1.24 | 1.86 | 5.41 | 0.03 | 0.018 | 0.022 | 0.5 |
| Invention alloy 2 | Bal. | 22.8 | 16.5 | 3.07 | 1.23 | 1.84 | 5.36 | 0.03 | 0.018 | 0.022 | 1.5 |
| Invention alloy 3 | Bal. | 22.5 | 16.4 | 3.04 | 1.22 | 1.82 | 5.30 | 0.03 | 0.018 | 0.022 | 2.5 |
| Comparative | Bal. | 28.6 | 12.8 | 2.4 | 1.0 | 2.0 | 7.4 | 0.03 | 0.01 | 0.02 | — |
| alloy 2 | | | | | | | | | | | |
| Invention alloy 4 | Bal. | 27.5 | 12.3 | 2.3 | 0.96 | 1.92 | 7.1 | 0.03 | 0.01 | 0.02 | 4 |

* Each elemental composition is indicated by “% by mass”.

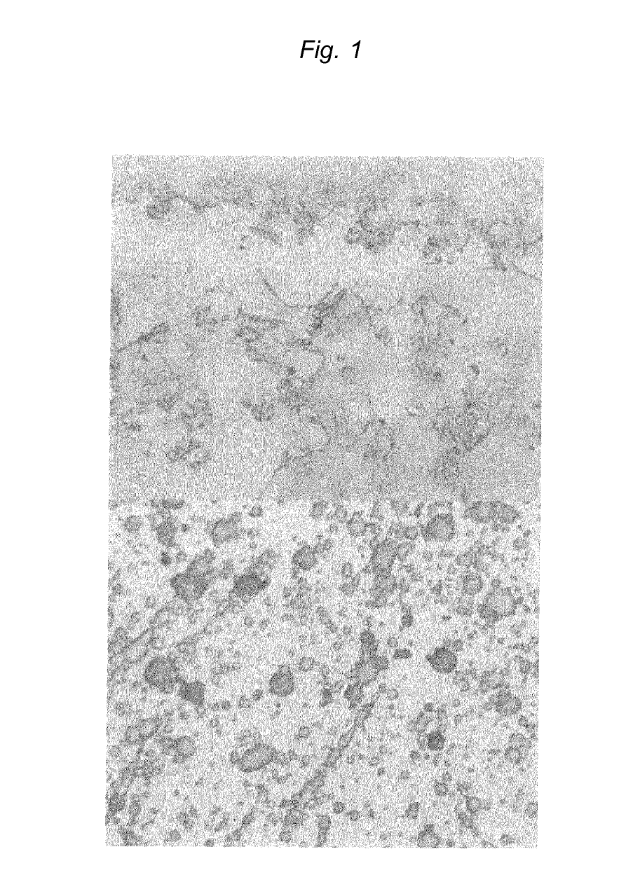

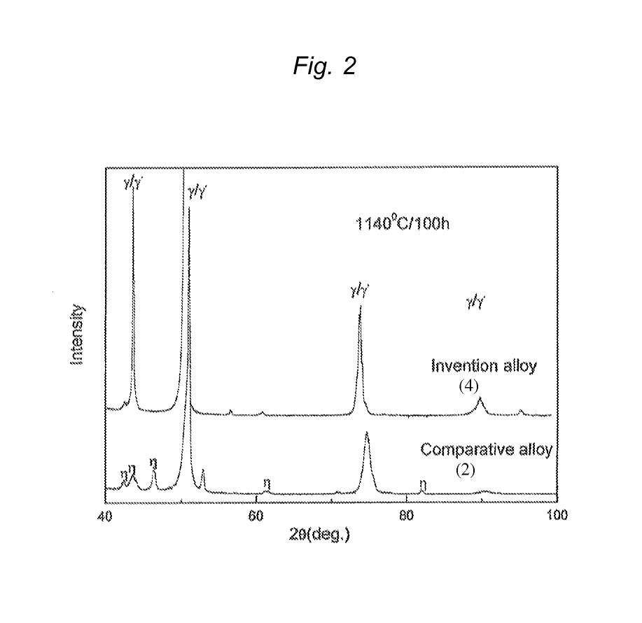

In all the invention alloys, the formation of a TCP phase which is a detrimental phase, especially the formation of an η phase (Ni₃Ti) was suppressed, and the improvement effect for the stability of the microstructure by the addition of ruthenium was recognized. For example, as shown in FIG. 1, in the cast alloy of the comparative alloy 2 (A), the formation of an η phase was found on the grain boundary, whereas, in the invention alloy 4 (B) obtained by adding ruthenium in an amount of 4% by mass to the comparative alloy 2, the formation of an η phase was not recognized. With respect to these two alloys, the stability of the microstructure in a heat treatment was evaluated. Specifically, the two alloys were individually subjected to heating treatment at 1,220° C. for one hour, and then cooled with water, and subsequently, subjected to aging treatment in a temperature region of from 700 to 1,200° C. for 1 to 1,000 hours. FIG. 2 shows X-ray diffraction patterns of the two alloys which have been subjected to aging treatment at 1,140° C. for 100 hours. In the comparative alloy 2 which has been subjected to aging treatment, diffraction peaks ascribed to the η phase as well as the γphase and γ′ phase were observed, but, in the invention alloy 4 having ruthenium added in an amount of 4% by mass, contrary to the comparative alloy 2, a diffraction peak ascribed to the η phase was not observed.

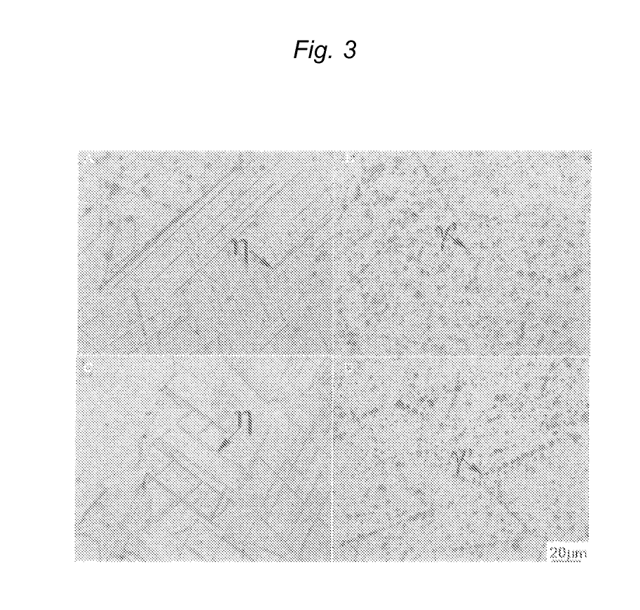

FIG. 3 shows photomicrographs of the microstructures observed with respect to the invention alloy 4 and comparative alloy 2, which have been subjected to heat treatment at 1,220° C. for one hour and then subjected to aging treatment at 1,140° C. for 32 hours and for 100 hours. As can be seen from the photomicrographs, in the comparative alloy 2 {(A) and (C)}, a number of η phases in a plate form having a size of several hundred microns were observed, which are not observed in the invention alloy 4 {(B) and (D)}. These results clearly show the remarkable effect achieved by the addition of ruthenium in the heat-resistant superalloy of the invention.

Table 2 shows the results of the measurement of a compressive stress at yield and a compressive creep at 725° C./630 MPa with respect to the invention alloys and comparative alloys shown in Table 1.

TABLE 2

| | | | | | | Compressive |
|---|---|---|---|---|---|---|
| | | | | | | creep |
| | Compressive stress at yield (MPa) | | | | | (s⁻¹) |
| Name of | 25° | 400° | 700° | 800° | 1000° | 725° C./ |
| alloy | C. | C. | C. | C. | C. | 630 MPa |
| Comparative | 873 | 864 | 861 | 847 | 340 | 5.21 × 10⁻⁸ |
| alloy 1 | | | | | | |
| Invention | 890 | 886 | 881 | 859 | 344 | 3.27 × 10⁻⁸ |
| alloy 1 | | | | | | |
| Invention | 894 | 867 | 859 | 848 | 340 | 1.85 × 10⁻⁸ |
| alloy 2 | | | | | | |
| Invention | 868 | 861 | 842 | 828 | 335 | 1.71 × 10⁻⁸ |
| alloy 3 | | | | | | |
| Comparative | 929 | 923 | 920 | 916 | 341 | 1.35 × 10⁻⁸ |
| alloy 2 | | | | | | |
| Invention | 917 | 915 | 911 | 911 | 358 | 1.19 × 10⁻⁸ |
| alloy 4 | | | | | | |

The results shown in Table 2 are those measured with respect to the invention alloys and comparative alloys, which have been subjected to heat treatment at 1,100° C. for 4 hours and air cooling, and then subjected to aging treatment at 650° C. for 24 hours and at 760° C. for 16 hours. The compression test was conducted using a tester (SHIMAZU AG50KNI), manufactured by Shimadzu Corporation, in a temperature region of from room temperature to 1,000° C. at an apparent strain rate of 3×10⁻⁴ s⁻¹. The invention alloys have a compressive stress at yield substantially equivalent to that of the comparative alloys, and these results indicate that the addition of ruthenium does not adversely affect the compressive stress at yield of the alloy. Further, in some of the invention alloys, an effect such that the addition of ruthenium improves the performance is also recognized. Particularly, in the invention alloy 3 obtained by adding ruthenium in an amount of 2.5% by mass to the comparative alloy 1, the compressive creep is drastically improved from 5.2×10⁻⁸ s⁻¹ to 1.71×10⁻⁸ s⁻¹. Accordingly, the results shown in Table 2 suggest that the addition of ruthenium in the heat-resistant superalloy of the invention achieves an effect such that the processability of the heat-resistant superalloy is remarkably improved without sacrificing the heat resistance.

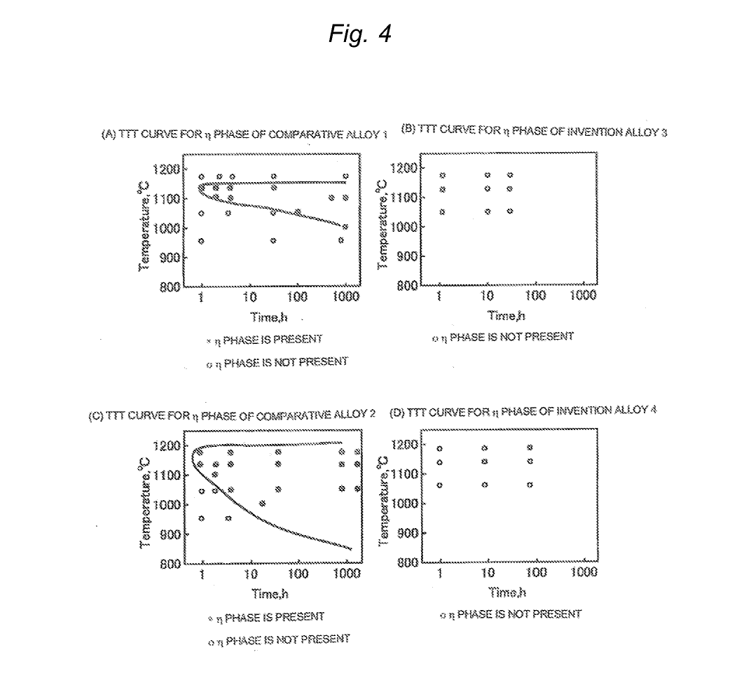

FIG. 4 shows the suppression effect for the η phase formation in the invention alloy having ruthenium added thereto. FIGS. 4(A) and 4(C) show TTT curves (time-temperature-transition curves) for the formation of an η phase with respect to the comparative alloys 1 and 2, respectively. The TTT curves of the comparative alloys 1 and 2 had a C-shape, and the nose temperature and the temperature range in which the presence of an η phase is recognized were about 1,000° C. and the range of from 1,100 to 1,150° C., respectively, with respect to the comparative alloy 1, and about 1,170° C. and the range of from 850 to 1,200° C., respectively, with respect to the comparative alloy 2. That is, in each of the comparative alloys 1 and 2, η phases are present in a wide range (the region in which symbols * are present). In contrast, as shown in FIGS. 4(B) and 4(D), in each of the invention alloys 3 and 4, the formation of an η phase was not recognized in any region. These results clearly show that the addition of ruthenium in the heat-resistant superalloy of the invention remarkably improves the stability of the phase.

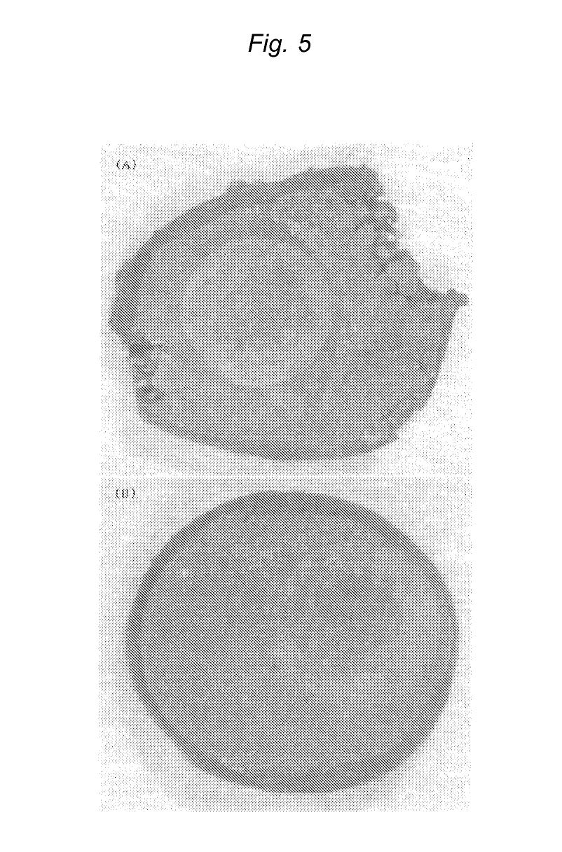

An existing disk alloy, such as U720LI, is generally subjected to high-temperature forging at about 1,100° C., and the deformability of an alloy in a similar temperature region is an important factor in presuming the workability of the alloy in the processing. Using the invention alloy 4 and comparative alloy 2, workability was evaluated by a high-temperature compression test with respect to each of these alloys. The evaluation of the workability was conducted at 1,100° C. and at a strain rate of 0.1 s⁻¹. Each of the alloys was maintained at the temperature for the measurement for 10 minutes so that the alloy became homogeneous, and then a strain of 0.65 was applied to the alloy to effect deformation, followed by rapid cooling using water. As shown in FIG. 5, in the comparative alloy 2 containing an η phase, large cracks are caused, which confirms that the workability is very poor. By contrast, in the invention alloy 4 having ruthenium added thereto, only slight cracks are observed in the outermost shell, and, from this, it is considered that the ruthenium added to the alloy suppresses the formation of an η phase, remarkably improving the workability in the high-temperature forging processing.

### INDUSTRIAL APPLICABILITY

The heat-resistant superalloy of the invention has a good balance between excellent heat resistance and easy processing properties, and has high reliability and is used in a heat-resistant member for use in aircraft engine, generator gas turbine, or the like, particularly used in a turbine disk, a turbine blade, or the like.

1-12. (canceled)

13. A method for forging a heat-resistant superalloy comprising forging the heat-resistant superalloy at about 1100° C., wherein the heat-resistant superalloy comprises chromium, aluminum, cobalt, titanium, and ruthenium as main components, optionally a subcomponent(s), and a remainder, excluding the main components and the subcomponent(s), of nickel and an inevitable impurity, wherein
an amount of the chromium is 2 to 25% by mass,
an amount of the aluminum is 0.2 to 7% by mass,
an amount of the cobalt is 19.5 to 55% by mass,
an amount of the titanium is [0.17×(% by mass for cobalt-23)+3] to [0.17×(% by mass for cobalt-20)+7]% by mass, with the proviso that the amount of the titanium is 5.1% by mass or more, and
an amount of the ruthenium is 0.1 to 10% by mass.

14. The method according to claim 13, wherein a turbine disk is formed by forging the heat-resistant superalloy at about 1100° C.

15. A heat-resistant superalloy comprising chromium, aluminum, cobalt, titanium, and ruthenium as main components, optionally a subcomponent(s), and a remainder, excluding the main components and the subcomponent(s), of nickel and an inevitable impurity, wherein
an amount of the chromium is 2 to 25% by mass,
an amount of the aluminum is 0.2 to 7% by mass,
an amount of the cobalt is 19.5 to 55% by mass,
an amount of the titanium is [0.17×(% by mass for cobalt-23)+3] to [0.17×(% by mass for cobalt-20)+7]% by mass, with the proviso that the amount of the titanium is 5.1% by mass or more, and
an amount of the ruthenium is 0.1 to 10% by mass, and
wherein a turbine disk is produced by high-temperature forging the heat-resistant superalloy at about 1100° C.
